(19) United States
(12) Patent Application Publication
(10) Pub. No.: US 2007/0193827 A1
(43) Pub. Date: Aug. 23, 2007

(54) Ladder Support Device

(76) Inventor: John Patrick Lambert, Stockport (GB)

Correspondence Address: SPECKMAN LAW GROUP PLLC, Suite 330, 1201 Third Avenue, Seattle, WA, 98101, US

(21) Appl. No.: 11/675,595

(22) Filed: Feb. 15, 2007

(30) Foreign Application Priority Data
Feb. 17, 2006 (GB) 0603185.0

(51) Int. Cl. E06C 7/42

(52) U.S. Cl. 182/108

(57) ABSTRACT

A ladder support device, comprising a base plate having an upper surface and a lower surface; an upstanding walling that extends from the upper surface to define a well for receiving a lower end of a ladder side member; and at least one spike extending from the lower surface of the base plate, wherein the upstanding walling delimits an inner region of the base plate in which at least one aperture is provided, wherein the location of the at least one spike and the location of the at least one aperture are arranged so that two ladder support devices may be fitted together such that the at least one spike of a first ladder support device extends through the at least one aperture of a second ladder support device from the lower surface of the base plate of the second ladder support device, and wherein the at least one spike are surrounded by the walling of the second ladder support device.

### CROSS REFERENCE TO RELATED APPLICATION(S)

This application foreign priority to United Kingdom Patent Application No. 0603185.0, filed Feb. 17, 2006.

### FIELD OF INVENTION

This invention generally relates to a support device for the base of a ladder.

### BACKGROUND OF THE INVENTION

Ridged support mats for the base of a ladder have been previously proposed. A support mat with a substantially rigid upstand, slidably retained in a groove extending across the mat, for abutment of the lower ends of ladder uprights is also known.

### SUMMARY OF THE INVENTION

A ladder support means specifically for use on soft substrates, such as soil or grass, but also taking account of safety requirements when ground penetrating means, such as spikes, is provided.

The ladder support device comprises a base plate having upper and lower major surfaces, an upstanding walling that extends from the upper surface to define a well for reception of a lower end of a ladder side member, and at least one spike that extends from the lower surface for purposes of ground penetration. The upstanding walling also delimits an inner region of the base plate in which at least one aperture is provided. The location of the spike or spikes and the location of the aperture or apertures are arranged so that two ladder support devices may be fitted together with the spike or spikes of a first ladder support device extending through the aperture or apertures of a second device from the lower surface of the base plate of the second ladder support device so that the spike or spikes are then surrounded by the walling of the second ladder support device.

In one embodiment of the inventive ladder support device, at least two spikes are provided which extend from the lower surface of the base plate and at least two apertures are correspondingly provided in the inner region of the base plate. Advantageously, these spikes and apertures are located at positions around the circumference of an imaginary circle having its center approximately at the center of the base plate. A symmetrical arrangement is most convenient.

The upstanding walling may be continuous or may be provided as several separate walls with gaps or notches there between.

The upstanding wall or walls are configured or arranged so that the well and the inner region of the base plate which it/they define are rectangular in shape. However, other shapes, such as a circular wall/inner region may also be utilized.

### BRIEF DESCRIPTION OF THE DRAWINGS

The present invention will be described in greater detail in the following detailed description, with reference to the accompanying drawings, wherein:

FIG. 1 is a top view of an embodiment of a ladder support device;

FIG. 2 is a side view of the ladder support device shown in FIG. 1;

FIG. 3 is another side view of the ladder support device shown in FIG. 1;

FIG. 4 is a perspective view of the ladder support device shown in FIG. 1;

FIG. 5 is a perspective view of two ladder support devices about to be fitted together, one of them being inverted relative to the other; and

FIG. 6 shows the two devices of FIG. 5 once they are interlocked.

### DETAILED DESCRIPTION OF THE INVENTION

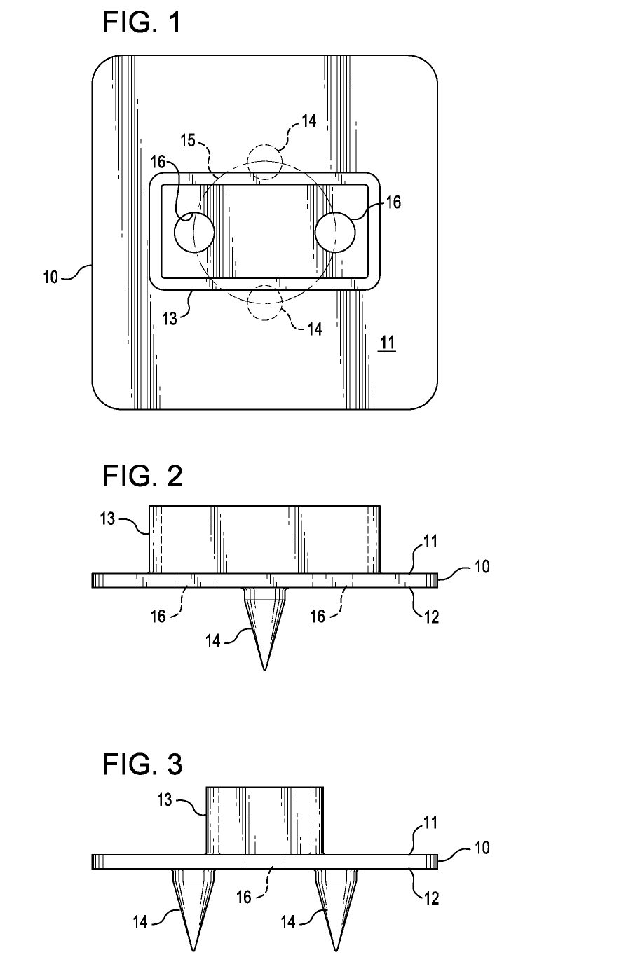

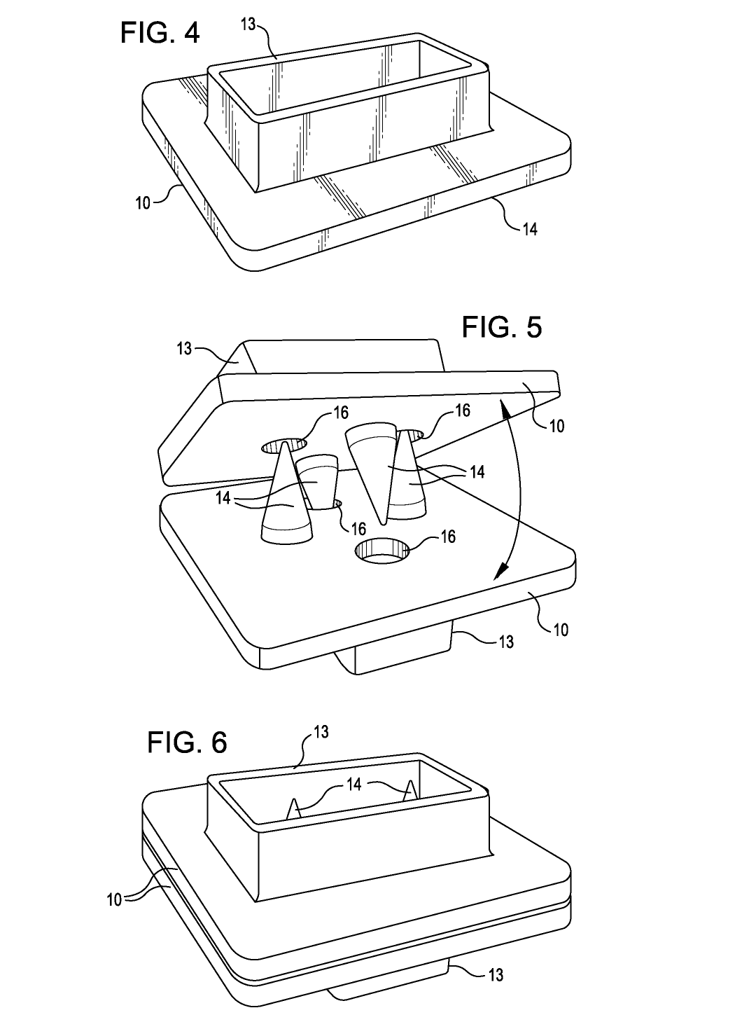

In the embodiment as shown in FIGS. 1-6, the inventive ladder support device comprises a base plate 10 having upper and lower major surfaces 11, 12, an upstanding continuous wall 13 that extends from the upper surface 11, and two spikes 14 projecting from the lower surface 12. The base plate 10 and the wall 13 are fabricated from robust, substantially rigid material, such as reinforced heavy duty plastics material. The plate 10 is substantially square in shape, with rounded corners, and may suitably be in the region of 15 cm square. The wall 13 is configured to define a substantially rectangular upwardly open receptacle, which is referred to here as “a well”. It also delimits, as the base of the well, a central or inner region of the base plate 10 in which two apertures 16 are provided. In one embodiment, the inner region of the base plate 10 may be approximately 10 cm×5 cm in dimensions.

As shown in FIG. 1, the two spikes 14 and the two apertures 16 are provided at locations spaced 90° apart around the circumference of an imaginary circle 15 having its center approximately at the center of the base plate 10. The respective apertures 16 lie opposite each other at 180° apart towards respective ends of the rectangular well, while the respective spikes 14 are arranged to extend from the lower surface 12 of the plate 10 at opposing locations midway between the circumferential locations of the apertures 16.

In use, at least two ladder support devices are supplied to support a ladder above relatively soft ground (typically soil or grass). Firstly, the required positions of the lower ends of the ladder uprights are ascertained by placing the ladder in position and pressing down to make indentations in the ground. The ladder is then put to one side and the two support devices are appropriately positioned and pressed down so that their spikes 14 penetrate the ground. The ladder is then re-positioned with the lower ends of its uprights fitting into the respective wells provided by the walls 13 of the two devices and abutting said walls 13. The base plates 10 serve to spread the load of the ladder and the person who will be using it to the relatively soft ground below. The ground penetrating spikes 14 reliably prevent slippage of the devices and the ladder.

However, the provision of spikes 14, which are the only reliable means of ensuring that there is no slippage when a ladder is used above soft ground, gives rise to a safety risk when the devices are not in use. To minimize any risk of damage or injury from the spikes during storage between uses, the devices are designed to fit together in the manner shown in FIGS. 5 and 6. The lower surfaces 12 of the respective base plates 10 are brought together and one of the base plates 10 is turned through 90° relative to the other so that the spikes 14 of each device fit through the apertures 16 of the other device. The respective pairs of spikes 14 thereby project upwardly into the well defined by the wall 13 of the other device and accordingly are shielded by the said surrounding wall 13. Obviously, the height of the wall 13 should be chosen to be slightly greater than the length of the spikes 14 so that the latter are adequately shielded and unlikely to cause damage or injury while the support devices are not being used and are fitted together in this way.

The foregoing is illustrative and not limitative of the scope of the invention. Many variations in detail would be possible in other embodiments. For example, the plate itself could be rectangular or circular or any other shape. Similarly, the upstanding wall could be arranged to surround a region of the plate which is circular or square or any other shape and there need not be a large region of the plate outside the wall, or indeed any region of the plate outside the wall, i.e. the wall could be around the edge of the plate in other embodiments. Also, it would be possible to have only a single spike and therefore only a single aperture for interfitting. Where there are two spikes and two apertures, these could be positioned differently to the illustrated embodiment. There could feasibly be three or more spikes and corresponding apertures, and positioning of these could be worked out to allow them to inter-engage when the lower surfaces of two devices are brought together with one of the plates turned through an appropriate angle to allow the inter-engagement. It is only necessary that the apertures are formed within the protective barrier of the encircling wall or walls which define the well for receiving the end of the ladder upright. As mentioned earlier, a single continuous wall is not essential and several walls with narrow gaps between would serve equally well to provide the abutment for the foot of the ladder and the shield for the spike (s) when the devices are not in use.

While certain embodiments of the present invention have been described, it will be understood that various changes could be made in the above constructions without departing from the scope of the invention. It is intended that all matter contained in the above description or shown in the accompanying drawings shall be interpreted as illustrative and not in a limiting sense.

I claim:

1. A ladder support device, comprising:
(a) a base plate having an upper surface and a lower surface;
(b) an upstanding walling that extends from the upper surface to define a well for receiving a lower end of a ladder side member; and
(c) at least one spike extending from the lower surface of the base plate, wherein the upstanding walling delimits an inner region of the base plate in which at least one aperture is provided, wherein the location of the at least one spike and the location of the at least one aperture are arranged so that two ladder support devices may be fitted together such that the at least one spike of a first ladder support device extends through the at least one aperture of a second ladder support device from the lower surface of the base plate of the second ladder support device, and wherein the at least one spike are surrounded by the walling of the second ladder support device.

2. The ladder support device of claim 1, wherein the ladder support device comprises at least two spikes extending from the lower surface of the base plate, and wherein at least two apertures are provided in the inner region of the base plate.

3. The ladder support device of claim 2, wherein the at least two spikes and the at least two apertures are positioned around the circumference of a circle, wherein the center of the circle is positioned approximately at a center of the base plate.

4. The ladder support device of claim 3, wherein the spikes and the apertures are located and positioned symmetrically.

5. The ladder support device of claim 1, wherein the base plate has a generally square configuration.

6. The ladder support device of claim 1, wherein the upstanding walling is configured so that the well it defines has a substantially rectangular configuration.

7. The ladder support device of claim 1, wherein the upstanding walling is continuous.

8. The ladder support device of claim 1, wherein the upstanding walling comprises a plurality of separate walls having gaps or notches there between.
